(19) United States
(12) Patent Application Publication
(10) Pub. No.: US 2026/0070618 A1
(43) Pub. Date: Mar. 12, 2026

(54) KING PIN ARRANGEMENT, SEMITRAILER, KING PIN AND METHOD FOR DETECTING A DRIVING STATE OF A SEMITRAILER

(71) Applicant: Jost - Werke Deutschland GmbH, Neu-Isenburg (DE)

(72) Inventors: Paul HANSEN, Neu-Isenburg (DE); José Manuel ALGÜERA GALLEGO, Aschaffenburg (DE); Stephan GITZEN, Riedstadt (DE); Swen SAUPE, Mainz (DE)

(21) Appl. No.: 19/319,357

(22) Filed: Sep. 4, 2025

(30) Foreign Application Priority Data
Sep. 6, 2024 (DE) 10 2024 125 638.9

(51) Int. Cl. B62D 53/08

(52) U.S. Cl. CPC B62D 53/0842

(57) ABSTRACT

The present invention relates to a king pin arrangement, a semitrailer, a king pin and a method for detecting a driving state of a semitrailer.

### CROSS-REFERENCE TO RELATED APPLICATION

This application claims the benefit of German Application No. 10 2024 125 638.9, filed on Sep. 6, 2024, the disclosure of which is incorporated by reference herein in its entirety.

### FIELD OF THE INVENTION

The present invention relates to a king pin arrangement, a semitrailer and a method for detecting a driving state of a semitrailer.

### BACKGROUND

King pins are used as coupling means between a semitrailer and a towing vehicle. The semitrailer and towing vehicle together form a tractor-trailer combination, also known as a truck-trailer combination. The king pin is usually attached to the semitrailer. During the coupling procedure, a fifth wheel coupling on the tractor vehicle slides over the king pin. A lock inhibits the king pin from coming loose.

When the tractor-trailer combination is traveling straight ahead, three driving states can occur with regard to the forces acting on the king pin: pulling mode, pushing mode, and a neutral driving state. In pulling mode, the tractor pulls the semitrailer via the king pin. In pushing mode, the opposite occurs: the semitrailer pushes the tractor. Pushing mode occurs, for example, when the tractor is actively braked. In neutral driving state, no forces act between the tractor and the semitrailer in the direction of travel. In practice, the neutral driving state occurs rarely and usually only temporarily.

When used as intended, the king pin transmits a large part of the forces between the towing vehicle and the trailer, in particular the pulling and pushing forces when accelerating and braking the combination. Due to the high forces, the king pin wears out over time. Even if the king pin is held in the fifth wheel with virtually no play at the beginning of its service life, the play increases over time due to wear. For this reason, king pins are often designed to be replaceable. For this purpose, the king pin has a pin section and a flange section, whereby the pin section is used for force transmission and the flange section is used to fasten the king pin to the semitrailer. It is usually fastened to a king-pin plate on the semitrailer, which has a receptacle for the king pin or its flange section. The king-pin plate can be welded into a recess in the floor of the semitrailer. Such an arrangement is known, for example, from DE 1 038 923 B.

Manufacturers of semitrailers, tractors, and tractor-trailer combinations have a fundamental interest in obtaining information about the driving state at a given point in time. In particular, there is interest in continuously recording and, if necessary, controlling the driving state. Several systems known from the prior art therefore attempt to enable this.

GB 2486474 A discloses a king pin in which piezo elements are integrated into the pin body. Piezo elements change their electrical conductivity when mechanical stress is applied to them. The king pin has two piezo elements in the edge area. One piezo element is arranged at the front in the direction of travel and one piezo element at the rear in the direction of travel. In this way, the pushing mode can be detected by the piezo element arranged at the front and the pulling mode by the piezo element arranged at the rear. The piezo elements do not allow any further conclusions to be drawn.

EP 2 899 101 A1 discloses a king pin which is attached to a semitrailer by means of a support plate. The king pin and support plate have a common vertical bore that runs centrally in the king pin. A lever is arranged in the bore, to which forces are transmitted in tensile and pushing modes by means of two spring elements, causing the lever to pivot. The pivoting movement of the lever is detected by sensing elements, which can be used to determine the vehicle status. The spring elements are arranged in radial bores which are connected to the vertical bore. The radial bores greatly weaken the king pin in this apparatus, so that there is a risk of the king pin breaking.

The above-mentioned sensors are not sufficient for current purposes. In the course of the increasing automation and autonomization of tractor-trailer combinations, it is desirable to obtain more detailed information about the condition of the king pin and the driving state of the tractor-trailer combination.

The subject invention encompasses embodiments of king pin arrangements that provide information about the condition of the king pin and the driving state of the tractor-trailer combination.

### SUMMARY OF THE INVENTION

The king pin arrangement comprises the following components: a king pin with a flange section and a pin section, a king pin plate with a receptacle for the king pin, a fastening means by means of which the king pin is fastened to the king pin plate, and optionally a measurement provider. According to the invention, a measuring unit is provided in or on one of the components, which is configured to map a deformation of the component as an electrical measurand.

The inventors have recognized that the deformation of the aforementioned components allows far-reaching and accurate conclusions to be drawn about the driving state and the force ratios between the semitrailer and the towing vehicle. If the deformation is made electrically measurable, information about the current state of the deformation can be easily transported. In this way, this information can be made available to the towing vehicle, for example, without great effort.

In the following, an axis running parallel to the direction of travel of a vehicle is referred to as the longitudinal axis. The vertical axis is the axis that runs vertically and centrally through the king pin. The vertical axis can also be referred to as the central axis and represents the pivot point between the towing vehicle and the semitrailer. An axis referred to as the transverse axis runs perpendicular to the longitudinal axis and the vertical axis. A longitudinal plane of the vehicle is spanned by the longitudinal axis and the vertical axis. A transverse plane of the vehicle is spanned by the transverse axis and the vertical axis.

As described above, the king pin comprises a flange section and a pin section. The king pin is preferably essentially rotationally symmetrical. For fastening to the king pin plate, the king pin preferably has bores for the fastening means. The bores are preferably arranged in the flange section. The holes are also preferably arranged uniformly or even rotationally symmetrically on the king pin. In some embodiments, the flange section of the king pin has no holes for the fastening means. In such embodiments, the king pin can be pressed onto the king pin plate by a retaining ring as a fastening means. The retaining ring is preferably fastened to the king-pin plate with screws and, optionally, nuts. In both cases, the king pin is easily replaceable.

The king-pin plate preferably has a pan shape, whereby the pan shape is upside down during intended use. The receptacle for the king pin in the king pin plate is preferably a recess, which is advantageously rotationally symmetrical. However, the receptacle may also consist only of a flat surface. To secure the king pin, the receptacle preferably has holes through which the fastening means (screws) can pass.

Preferably, several fastening means are provided. The fastening means are preferably screws and optionally nuts. If only screws are provided, these are preferably pushed through the holes in the flange section or the retaining ring from below and then screwed into the king-pin plate. The holes in the king-pin plate then have an internal thread. In other embodiments, the fastening means comprise screws and nuts. The holes in the king pin or the retaining ring and the king pin plate are then only through holes without threads. The screws can then be pushed through the holes from below, for example, and locked at the top by a nut screwed onto the screw.

The positioning of the measuring unit is very important to ensure that the deformation of the respective component can be reproduced as accurately as possible by the measuring unit. The further the measuring unit is from the fastening points of the respective component, the more clearly deformations become noticeable. On the other hand, the forces causing the deformation are absorbed at the fastening points of the respective component, where they can be easily absorbed and recorded, which also allows conclusions to be drawn about the deformations. In the case of the king pin, the fastening points are defined by the fastening means. In the case of the king-pin plate, the fastening points are located where the king-pin plate is connected to the rest of the semitrailer, for example by welding.

A preferred location for the measuring unit is an interface between the fastening means and either the king pin or the king-pin plate. For example, the measuring unit can be arranged between the head of a screw serving as a fastening means and the flange section, between the head of a screw serving as a fastening means and the king-pin plate, between a nut serving as a fastening means and the flange section, or between a nut serving as a fastening means and the king-pin plate. Deformations of the components are particularly noticeable at these interfaces, as some of the forces causing the deformation are absorbed by the fasteners. Another boundary surface at which the measuring unit is preferably arranged is the boundary surface between the flange section of the king pin and the king pin plate. The measuring unit can be arranged both in the radial direction and in the axial direction along the vertical axis between the flange section and the king pin plate. Another, likewise preferred location for the arrangement of the measuring unit is the transition from the outer circumferential surface of the pin section to the flange section. Deformations of the pin section are particularly noticeable at this transition, which means that the deformation can be easily represented as an electrical measurand by the measuring unit. The measuring unit can also be arranged on an outer circumferential surface of the pin section, on a top side or bottom side of the flange section, or in a recess on a top side of the king-pin plate or the flange section.

Arranging the measuring unit on the measurement provider is also highly advantageous. A measurement provider is understood to be a component whose primary function is to amplify a deformation of one of the components with which the measurement provider is connected. In this way, even small deformations can be detected by a measuring unit arranged on the measurement provider. The measurement provider can, for example, be a measurement bar and/or connected to the king-pin plate. For example, the measurement bar can be welded to the king-pin plate at one end and connected to a chassis of the semitrailer at the other end. The measurement bar floats freely between them. The chassis is very rigid and hardly deforms even under high forces. If the king-pin plate deforms due to a force acting between the towing vehicle and the semitrailer, this deformation is transferred to the measurement bar and amplified there. The measuring unit arranged on the measuring bar can thus map the deformation of the measurement provider. The resulting measurand can be used to draw conclusions about the deformation of the king-pin plate. The measuring unit is preferably arranged centrally on the measurement provider. Even small deformations of the king-pin plate can thus be mapped well. The measurement provider can also be a sensor shaft arranged in a bore of the king pin, in particular a central bore.

Arranging the measuring unit on the king pin is particularly advantageous, as this has to be replaced frequently anyway due to wear. This means that the measuring units according to the invention can also be provided in older vehicles or semitrailers without the need for major modifications to the semitrailer. Arranging the measuring unit on a bottom side of the king-pin plate is also advantageous, as it is easily accessible when replacing the king pin. This makes maintenance or replacement of the measuring unit easy. Arranging the measuring unit directly on the king pin also has the advantage that an initial calibration can be carried out before the king pin is installed in the king pin assembly or in the semitrailer.

Arranging the measuring unit on the top side of the flange section is also advantageous, as this simplifies the cable guide from the measuring unit. A cover for the measuring unit can also be provided on the top side. The cover for the measuring unit protects the measuring unit from environmental influences.

The measuring unit is preferably arranged in a recess in the component. This has the advantage that the measuring unit does not protrude, so that adjacent components do not have to be laboriously adapted to the presence of the measuring unit. This means that standardized or existing components can continue to be used. The recess is preferably a groove or a long hole.

The measuring unit is preferably arranged on a radius. Radius refers in particular to the curvature of an edge or corner where a sharp transition between two surfaces is replaced by a circular arc. A radius is in particular a surface running around an axis that has the shape of a circular arc in cross-section. A radius can also be referred to as a rounding. A radius is often used, for example, at the transition from the flange section to the pin section of the king pin. It has been shown that measurement at radii is particularly advantageous, as the stress values are greatest there due to deformation. A preferred location for the measuring unit is therefore a transition from the flange section to the pin section of the king pin. Another particularly advantageous location for the measuring unit is at a radius of a recess on the top side of the flange section, in particular at the edge of the recess.

An evaluation device to which the measuring unit is connected is preferably provided for detecting and further processing the electrical measurand. The evaluation device is preferably part of the semitrailer and in particular of the kingpin arrangement so that the evaluation can also be carried out when there is no electrical or electronic connection to the towing vehicle (yet). The evaluation device is preferably arranged under the cover or is part of the cover.

The measuring unit preferably has an electrical resistance and two electrical connections. In this way, the electrical measurand of the measuring unit can be detected and further processed by the evaluation device connected to the two electrical connections. The measuring unit is particularly preferably a strain gauge or a piezo element. Piezo elements are particularly suitable for use between two components. The piezo elements are preferably provided with a pre-tension between the two components. Deviations from this pre-tension can then be detected and conclusions about the respective deformations can be drawn from these values. The use of such piezo elements also offers the advantage that the set pre-tension can be detected. This makes it possible to determine during initial installation whether the desired pre-tension has been achieved or whether, for example, a screw has been forgotten.

The component may have a cable guide, which preferably comprises a groove and/or a bore. The cable guide preferably opens onto the electrical connections and/or the evaluation device. In this way, a cable can be routed through the component from the electrical connections so that the measuring unit can be connected to an evaluation device. Components without a measuring unit may also have a cable guide. The cable guide may also be connected to a transmitter of a contactless communication system, which transmits the signal from the measuring unit to a receiver, which is located, for example, on the towing vehicle. The receiver is then preferably connected to the evaluation device. The cable guide may also be connected to a plug of a plug system. The plug is preferably complementary to a plug of the towing vehicle. In this way, the measurand of the measuring unit can also be determined by the towing vehicle or an evaluation device of the towing vehicle.

The cables coming from the measuring unit or from several measuring units can be combined in a plug that can be connected, for example, to the evaluation device. This allows, for example, the evaluation device to remain on the vehicle while a component with its measuring units can be easily replaced.

It is also possible to arrange the evaluation device for the measuring unit or the measuring group under the cover, resulting in a compact overall device. The cover may have a central bore for the sensor shaft.

In some embodiments, several measuring units are used. If measuring units are arranged at comparable locations, they are referred to as alike. For example, several alike measuring units can be arranged around the vertical axis at the transition from the outer circumferential surface of the pin section to the flange section. In addition, further measuring units may also be arranged at another location, for example on the measurement provider. Alike arranged measuring units are preferably distributed uniformly, for example around the vertical axis. It is particularly preferred that at least three alike arranged measuring units are provided. Three measuring units span a plane and can therefore map deformations of the respective component particularly well.

Measuring units can be combined into measuring groups. The measuring units of a measuring group are evaluated together by an evaluation device. It has proven particularly advantageous if the measuring units within their measuring group are connected to each other in a bridge circuit, in particular to a Wheatstone full bridge. For this purpose, four measuring units are provided, two of which are connected in series and thus form a strand. The two strands, each with two measuring units, are connected in parallel. By measuring the voltage between the two points, which are located between the measuring units of a strand, conclusions can be drawn about the size of the resistances of the measuring units and thus about the deformation of the associated component.

The measuring group preferably detects deformation of the king pin about the longitudinal axis or about the transverse axis. The measuring units of a measuring group are preferably arranged mirror-symmetrically to the longitudinal plane and/or the transverse plane. This allows the deformation of the king pin about the longitudinal axis or about the transverse axis to be detected particularly well. Alternatively or additionally, the measuring units of a measuring group can be arranged rotationally symmetrically about a central axis of the king pin. Several measuring groups can also be provided, which are designed to detect different deformations or the deformation of different components, whereby all measuring groups are preferably connected to the same evaluation device.

The measuring unit is preferably connected to a voltage source, which may be part of the tractor. During the coupling procedure of the tractor and semitrailer, there may be no or only a partial electrical connection between the tractor and the semitrailer. In order to be able to detect the deformations even during the coupling procedure, a voltage source is preferably provided that is part of the semitrailer, in particular of the kingpin arrangement, and that supplies the measuring unit and the evaluation device with energy.

Embodiments of the invention can encompass a semitrailer with a kingpin arrangement as described above and a tractor-trailer combination with a tractor vehicle and this semitrailer. Certain embodiments include a king pin in which a measuring unit is provided in or on the king pin, which is configured to map a deformation of the king pin as an electrical measurand. The king pin is preferably designed for use in a king pin arrangement. The king pin is preferably designed as described above.

The invention also encompasses methods for detecting a driving state of a semitrailer. A kingpin arrangement according to the above description is provided. The electrical measurand, in particular the resistance, of the measuring unit is detected by the evaluation device and the deformation of the associated component is determined from this.

In advantageous embodiments, the measuring unit is provided on the king pin and an initial calibration is performed before the king pin is installed in the king pin arrangement or in the semitrailer.

The measurands of the measuring unit change over time due to wear, distortion, temperature influence, and the like. The method therefore preferably includes the possibility of recalibration. A signal is generated when the semitrailer is in a decoupled state. The signal is transmitted to the evaluation device. The evaluation device then sets the current value of the measurand of the measuring unit as the neutral value. Recalibration makes subsequent measurements more accurate. The signal to the evaluation device can be triggered automatically when uncoupling or manually by an operator. The signal can be transmitted from the tractor unit to the semitrailer, or the semitrailer can detect itself that the tractor unit has uncoupled.

The measuring units preferably determine whether the tractor-trailer combination is in the zero position (articulation angle equal to zero), i.e. whether the tractor and semitrailer are aligned in the same direction. For this purpose, several measuring units are provided, which are preferably connected in a Wheatstone bridge circuit. The zero position can be determined particularly accurately if two measuring groups, each with several, preferably four, measuring units are provided. The measuring units are preferably arranged uniformly around the vertical axis.

### BRIEF DESCRIPTION OF THE DRAWINGS

The invention is illustrated and explained by way of example with reference to the drawings. The figures listed below are shown in the drawings:

FIG. 1 schematically shows a king pin arrangement in a side view.

FIG. 2 schematically shows a king pin in a side view.

FIG. 3 schematically shows a king pin in a top view.

FIG. 4 schematically shows a king pin arrangement in a side view.

### DETAILED DESCRIPTION

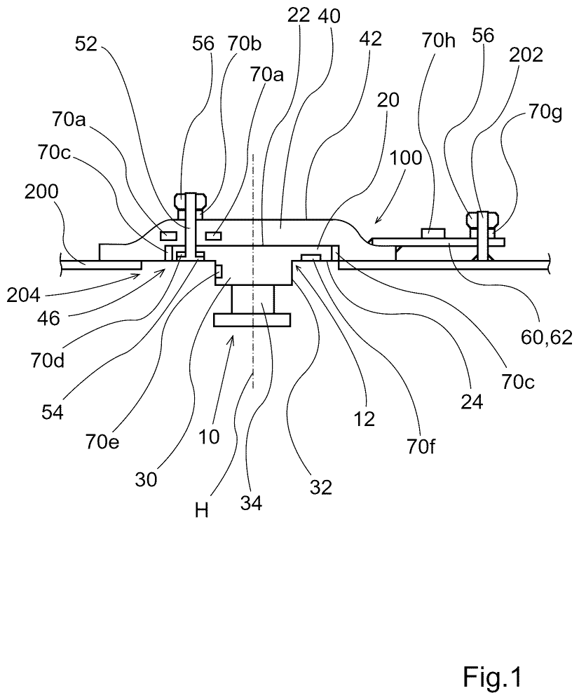

The king pin arrangement 100 shown in FIG. 1 has a king pin 10, a king pin plate 40, fastening means 50 and a measurement provider 60. The king pin 10 has a flange section 20 and a pin section 30, which are in one piece and merge into each other at a transition 12. The flange section 20 is disc-shaped, the pin section 30 is generally cylindrical and has a constriction 34 in which the king pin 10 is held by a fifth wheel coupling (not shown). The flange section 20 has a top side 22 and a bottom side 24. The bottom side 24 runs around the pin section 30. The king pin 10 defines a vertical axis H, which runs centrally through the pin section 30 of the king pin 10 and in a vertical direction.

The king-pin plate 40 is pan-shaped and has a receptacle 46 for the king pin 10 on its bottom side. The receptacle 46 is designed such that it can receive the flange section 20 of the king pin 10.

The king pin 10 is fastened to the king pin plate by means of the fastening means 50. The fastening means 50 are represented here by way of example by a screw 52 and a nut 56. King pin 10 and king pin plate 40 have holes aligned with each other, through which the screw 52 is inserted from below. The nut 56 is then fastened onto the screw 52, thereby connecting the two components, king pin 10 and king pin plate 40, to each other.

The kingpin assembly 100 is attached to a semitrailer floor 200. The semitrailer floor 200 has an aperture 204 for this purpose. The kingpin plate 40 is placed over the aperture 204 and welded there. The king pin 10 can then be fastened to the king pin plate 40 from below.

A threaded pin 202 is also provided on the semitrailer floor 200 to the side of the king pin plate, which runs parallel to the vertical axis H. The threaded pin 202 is welded to the semitrailer floor 200. The king-pin plate 40 is connected to the threaded pin 202 via a measurement bar 62 as a measurement provider 60. For this purpose, the measurement bar 62 is placed with a bore over the threaded pin 202. The measurement bar 62 is welded to the king-pin plate 40 at one end. However, another type of fastening between the king-pin plate 40 and the measurement bar 62 is also possible. A nut 56 is then screwed onto the threaded pin 202 and a pretension is generated.

In the kingpin arrangement 100 shown in FIG. 1, measuring units 70a, 70b, 70c, 70d, 70e, 70f, 70g, 70h are provided in and on several of the components, each of which is configured to map a deformation of the respective component as an electrical measurand.

Two measuring units 70a are installed in the body of the king-pin plate 40. These may be strain gauges, for example. If the king-pin plate 40 deforms, the electrical resistance of the measuring units 70a changes, which can be detected by an evaluation device (not shown). The measuring units 70a form a measuring group.

The measuring unit 70b is a piezo element that is placed on the top side 42 of the king-pin plate 40 around the screw 52 before the nut 56 is screwed onto the screw 52. The measuring unit 70b is thus located between the nut 56 and the king-pin plate 40. If the king-pin plate 40 is deformed, a force is exerted on the piezo element. This causes an electrical voltage to be generated at the piezo element, which can be measured by the evaluation device.

The measuring units 70c are arranged in the radial direction between the king pin 10, more precisely the flange section 20, and the king-pin plate 40. Several measuring units 70c are arranged in the circumferential direction rotationally symmetrically around the vertical axis H offset relative to one another, of which only two are shown. The measuring units 70c are piezo elements on which a voltage measurement can be performed as described above.

The measuring unit 70d is arranged in the form of a washer under a head 54 of the screw 52. The measuring unit 70d is thus arranged between the head 54 and the flange section 20 of the king pin 10. The measuring unit 70d is again a piezo element. If a force is exerted on the king pin 10, a force is ultimately exerted on the piezo element, which leads to a voltage that can be measured.

The measuring unit 70e is a strain gauge arranged on an outer circumferential surface 32 of the pin section 30. Deformation of the king pin 10 causes the electrical resistance of the strain gauge to change, which can be measured.

The measuring unit 70f is also a strain gauge. It is arranged on a bottom side 24 of the flange section 20 of the king pin 10. If the king pin 10 deforms, the electrical resistance of the strain gauge also changes, which can be detected by the evaluation device.

The measuring unit 70g is arranged between the measuring bar 62 and the nut 56 arranged on the threaded pin 202. The measuring unit 70g is a piezo element. If the king-pin plate 40 is deformed, this deformation is transferred to the measurement bar 62 and amplified there. The measurement bar 62 then exerts a force on the measuring unit 70g, which generates an electrical voltage due to the piezo effect, which can be detected.

A measuring unit 70h, which is a strain gauge, is arranged on the measurement bar 62 itself. If the measurement bar 62 deforms due to a deformation of the king-pin plate 40, the resistance of the strain gauge changes, which in turn can be detected by the evaluation device.

Each of the measuring units 70a to 70h described here can also be used in other embodiments without the remaining measuring units 70a to 70h or with only some of the measuring units 70 to 70h.

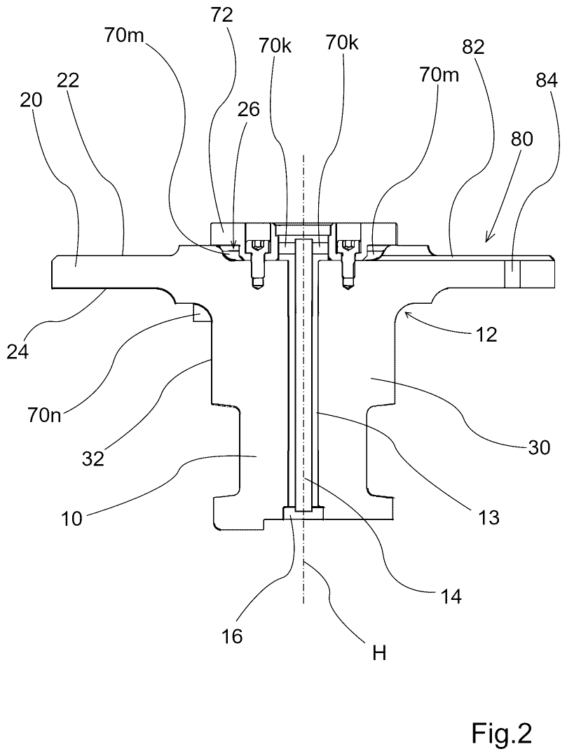

The king pin 10 shown in FIG. 2 also has a flange section 20 and a pin section 30, which merge into one another in the region of a transition 12. The king pin 10 has a central bore 13, inside which a sensor shaft 14 is arranged. The sensor shaft 14 is mounted at its lower end in a fixed bearing 16. At its upper end, the sensor shaft 14 is surrounded by measuring units 70k.

The measuring units 70k form a measuring group and are arranged between the sensor shaft 14 and the central bore 13 in a rotationally symmetrical manner about the main axis H. The measuring units 70k are piezo elements. If the king pin 10, in particular the pin section 30, is deformed, the sensor shaft 14 is bent and exerts forces on the measuring units 70k. The piezo effect causes a voltage to arise at the measuring units 70k, which can be detected for each measuring unit 70k. The force exerted on an individual measuring unit 70k depends on the direction of the load. This means that the direction of the load can be determined by an evaluation device (not shown) due to the different forces arising at the measuring units 70k.

A central recess 26 is provided on the top side 22 of the flange section 20. Several measuring units 70m are arranged rotationally symmetrically about the main axis H on the radially outer edge of the recess 26. The measuring units 70m are strain gauges. The measuring units 70m form a measuring group. It has been shown that measurement at radii, such as here at the edge of the recess 26, is particularly advantageous, since the stress values are greatest there due to deformation. Since there are several measuring units 70m, an evaluation device can determine from which direction the king pin 10 is loaded.

A measuring unit 70n is arranged in the transition area 12. The measuring unit 70n is a strain gauge. Here too, the deformation is measured in the area of a radius, as the stress values are highest there.

The measuring units 70a, 70b, 70c, 70d, 70e, 70f, 70g, 70h, 70k, 70m and 70n map deformations of the components as electrical measurands. In order to be able to detect the respective electrical measurand, it is advantageous if the measuring units are connected to an evaluation device (not shown) via conductors. The measuring units 70a, 70b, 70c, 70d, 70e, 70f, 70g, 70h, 70k, 70m and 70n have electrical connections for this purpose. Both the king pin 10 according to FIG. 2 and the king pin arrangement 100 according to FIG. 1 can have a cable guide 80 for guiding a connection cable to the evaluation device or to another location. In FIG. 2, the cable guide 80 comprises a groove 82 and a bore 84. The groove 82 and the bore 84 serve to conduct the signal from one measuring unit 70m. Starting from the measuring unit 70m, a conductor can be laid radially outwards through the groove 82 and then downwards through the bore 84. In the area where the conductor exits the bore 84 downwards, many trailers have a plug connector which is coupled to a complementary plug connector on the towing vehicle. In this way, the signal or the electrical measurand of the measuring unit 70m can be detected directly by the evaluation device on the towing vehicle. However, the evaluation device can also be part of the trailer.

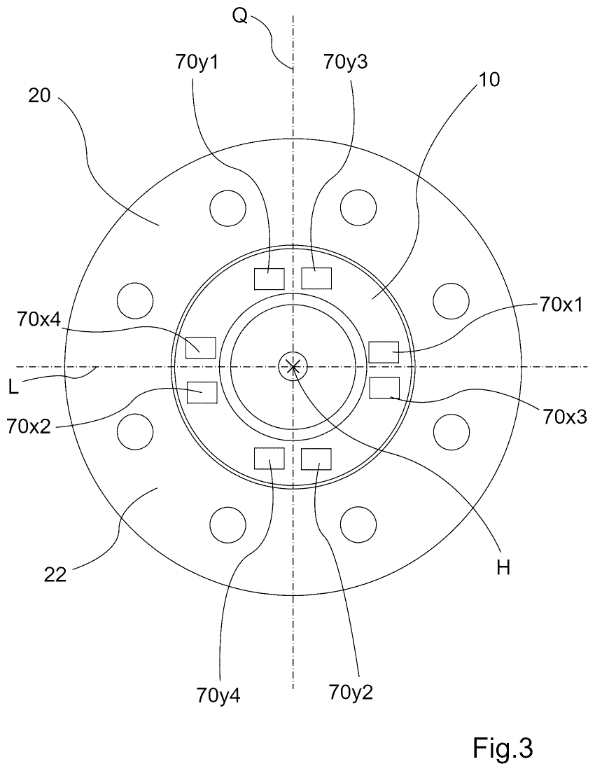

Several measuring groups are provided in the king pin 10 shown in FIG. 3. A first measuring group comprises four measuring units 70x1, 70x2, 70x and 70x4. A second measuring group comprises four measuring units 70y1, 70y2, 70y3 and 70y4. The measuring units within a measuring group are connected to form a Wheatstone measuring bridge. Within the measuring groups, the measuring units are arranged symmetrically to a longitudinal axis L and a transverse axis Q. The two measuring groups enable deformations of the king pin to be determined in a plane spanning the longitudinal axis L and the transverse axis Q. In addition, the measuring units 70x1-70y4 can be used to determine whether the tractor-trailer combination is in the zero position (angle of deflection equal to zero), i.e. whether the tractor vehicle and semitrailer are aligned in the same direction. The measuring units 70x1-70y4 are arranged uniformly around the vertical axis H.

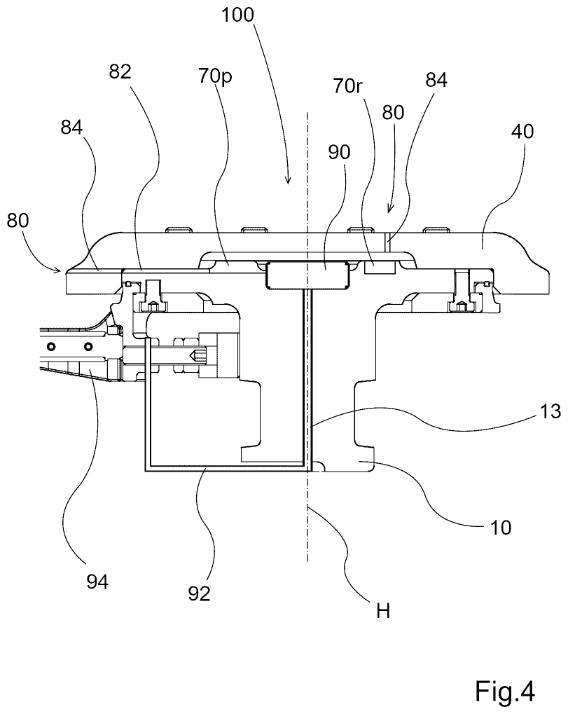

In the king pin arrangement 100 shown in FIG. 4, a king pin 10 and a king pin plate 40 are again provided. The king pin 10 is essentially rotationally symmetrical and is received with its flange region 20 in a receptacle 46 of the king pin plate 40.

The kingpin arrangement 100 comprises two measuring units 70p, 70r. The measuring units 70p, 70r are arranged on a top side 22 of the flange section 20. A groove 82 is provided in the top side 22 of the flange section 20 of the king pin 10, which serves as part of a cable guide 80. The groove 82 merges into a horizontal bore 84 in the king pin plate 40. A cable from the measuring unit 70p can be routed radially outward, first through the groove 82 and then through the bore 84, and then on to an evaluation device (not shown) that may be part of the trailer or the towing vehicle. The conductor can also be connected to a transmitter of a contactless communication system, which transmits the signal from the measuring unit 70p to a receiver, which is located, for example, on the towing vehicle. This type of transmission is possible with all measuring units 70a-70r. A vertical bore 84 is also provided in the king-pin plate 40, which serves as a cable guide 80 for the measuring unit 70r. A cable can be routed upwards from the measuring unit 70r at this point.

The king pin 10 has a central bore 13. The central bore 13 can also serve as a cable guide 80. In the embodiment shown here, a rotation angle sensor 90 is provided on the top side 22, the signal of which is also fed downwards through the central bore 13. The signal from the rotary angle sensor 90 is fed via a conductor 92 to a boom 94, from where it can be fed, for example, to a plug on the trailer (not shown). The cable guide 80 of the measuring units can be led to the plug in the same way in all embodiments.

### LIST OF REFERENCE SIGNS

10 King pin
12 Transition
13 Central bore
14 Sensor shaft
16 Fixed bearing
20 Flange section
22 Top side of the flange section
24 Bottom side of the flange section
26 Recess
30 Pin section
32 Outer circumferential surface of the pin section
34 Constriction
40 King-pin plate
42 Top side of king-pin plate
46 Receptacle
50 Fastening means
52 Screw
54 Head of screw
56 Nut
60 Measurement provider
62 Measurement bar
70a Measuring unit
70b Measuring unit
70c Measuring unit
70d Measuring unit
70e Measuring unit
70f Measuring unit
70g Measuring unit
70h Measuring unit
70k Measuring unit
70m Measuring unit
70n Measuring unit
70p Measuring unit
70r Measuring unit
72 Cover for the measuring unit
80 Cable guide
82 Groove
84 Bore
90 Rotary angle sensor
92 Conductor
94 Boom
100 Kingpin arrangement
200 Semitrailer floor
202 Threaded pin
204 Aperture
Q Transverse axis
L Longitudinal axis
H Vertical axis.

1. A king pin arrangement, comprising:
a king pin having a flange section and a pin section,
a king-pin plate with a receptacle for the king pin,
a fastening means by means of which the king pin is fastened to the king pin plate, and
optionally a measurement provider
characterized in that
a measuring unit is provided in or on one of the components, which is configured to map a deformation of the component as an electrical measurand.

2. The king pin arrangement according to claim 1,
characterized in that
the measuring unit is arranged at any of the following locations:
between a head of a screw serving as a fastening means and the flange section,
between a head of a screw serving as a fastening means and the king-pin plate,
between a nut serving as a fastening means and the flange section,
between a nut serving as a fastening means and the king-pin plate,
between the flange section and the king-pin plate,
on a radius,
at a transition from an outer circumferential surface of the pin section to the flange section,
on a top side or bottom side of the flange section,
(in a recess) on a top side of the king-pin plate or of the flange section,
on the outer circumferential surface of the pin section, or
on the measurement provider.

3. The king pin arrangement according to claim 1,
characterized in that
the measurement provider is a measurement bar and/or the measurement provider is connected to the king-pin plate.

4. The king pin arrangement according to claim 1,
characterized in that
the measuring unit is arranged in a recess of the component.

5. The king pin arrangement according to claim 1,
characterized in that
the measuring unit is arranged on a top side of the flange section and a cover is provided for the measuring unit.

6. The king pin arrangement according to claim 1,
characterized in that
an evaluation device is provided to which the measuring unit is connected, the evaluation device optionally being arranged under the cover or being part of the cover.

7. The king pin arrangement according to claim 1,
characterized in that
the measuring unit has an electrical resistance and two electrical connections and comprises a strain gauge or a piezo element.

8. The king pin arrangement according to claim 1,
characterized in that
the component has a cable guide, which comprises a groove and/or a bore.

9. The king pin arrangement according to claim 1,
characterized in that
at least three measuring units arranged alike are provided, which are optionally arranged uniformly distributed.

10. The king pin arrangement according to claim 1,
characterized in that
several measuring units form a measuring group that is connected to the evaluation device, and the measuring units are connected to one another within their measuring group to form a bridge circuit, optionally a Wheatstone full bridge.

11. The king pin arrangement according to claim 10,
characterized in that
the measuring group detects a deformation of the king pin about a longitudinal axis or about a transverse axis, wherein the measuring units of the measuring group are arranged mirror-symmetrically to a longitudinal plane and/or a transverse plane and/or rotationally symmetrically about a central axis of the king pin.

12. The king pin arrangement according to claim 10,
characterized in that
several measuring groups are provided, which are designed to detect different deformations or the deformation of different components, wherein all measuring groups are optionally connected to a same evaluation device.

13. The king pin arrangement according to claim 1,
characterized in that
the measuring unit is connected to a voltage source.

14. A semitrailer with a kingpin arrangement according to claim 1.

15. A king pin, comprising:
a measuring unit provided in or on the king pin, the measuring unit configured to map a deformation of the king pin as an electrical measurand.

16. A method for detecting a driving state of a semitrailer that has been uncoupled by means of a king pin arrangement according to claim 1, the method comprising:
detecting the electrical measurand by the measuring unit, and determining a deformation of the component from the electrical measurand.

17. The method of claim 16, further comprising carrying out a recalibration by generating a signal when the semitrailer is in a decoupled state, transmitting the signal to the evaluation device and the evaluation device then setting a current value of the measurand of the measuring unit as a neutral value.
